(19) United States
(12) Patent Application Publication
(10) Pub. No.: US 2019/0221882 A1
(43) Pub. Date: Jul. 18, 2019

(54) ANODE ACTIVE MATERIAL FOR LITHIUM SECONDARY BATTERY

(71) Applicant: KOREA INSTITUTE OF SCIENCE AND TECHNOLOGY, Seoul (KR)

(72) Inventors: Young Whan CHO, Seoul (KR); Ju Young JANG, Seoul (KR); In Yeong KANG, Seoul (KR); Young Su LEE, Seoul (KR); Jin Yoo SUH, Seoul (KR); Chan Soon KANG, Seoul (KR)

(73) Assignee: KOREA INSTITUTE OF SCIENCE AND TECHNOLOGY, Seoul (KR)

(21) Appl. No.: 16/102,849

(22) Filed: Aug. 14, 2018

(30) Foreign Application Priority Data
Jan. 18, 2018 (KR) 10-2018-0006714

(51) Int. Cl. H01M 10/0525; H01M 4/38; H01M 4/133; H01M 4/66

(52) U.S. Cl. CPC H01M 10/0525; H01M 4/668; H01M 4/133; H01M 4/386

(57) ABSTRACT

Provided is an anode active material for a lithium (Li) secondary battery, the material including silicon (Si)-based alloy powder, a carbonized layer at least partially surrounding the Si-based alloy powder serving as cores, and carbon nanofibers (CNFs) extending outward from a surface of the Si-based alloy powder through the carbonized layer.

### CROSS-REFERENCE TO RELATED PATENT APPLICATION

This application claims the benefit of Korean Patent Application No. 10-2018-0006714, filed on Jan. 18, 2018, in the Korean Intellectual Property Office, the disclosure of which is incorporated herein in its entirety by reference.

### BACKGROUND

### 1. Field

The present invention relates to an anode active material and a method of producing the same, and more particularly, to an anode active material for a lithium (Li) secondary battery and a method of producing the same.

### 2. Description of the Related Art

Due to development of information technologies (IT), use of portable electronic devices such as mobile phones and laptop computers is increased and demands for secondary batteries used as power sources of the portable electronic devices are also greatly increased. Compared to other types of secondary batteries, lithium (Li) secondary batteries are used as power sources of almost all IT devices due to high operating voltages, high energy densities, and long lives. Efforts are now being made to further develop existing technologies about the Li secondary batteries and to broaden use of the Li secondary batteries to electric vehicles and power storages. Due to abundance of resources, a low operating voltage, and a high theoretical capacity of 4,200 mAh/g (e.g., Li_{4.4}Si), silicon (Si) attracts much attention of people as an anode material for the Li secondary batteries, which can solve disadvantages of an existing graphite-based anode material. However, the Si anode material greatly changes in volume by more than 300% during charge and discharge of the battery to break electrodes, and generates unstable solid electrolyte interphase (SEI) to hinder long life characteristics of the battery. Currently, to solve the above problem, various methods capable of preventing electrode breakage and improving battery characteristics by reducing stress due to the change in volume by adopting nano-sized (D90<150 nm) Si. However, since Si nanoparticles are produced using complex and costly processes such as laser ablation and high energy pyrolysis of silane, mass production and commercialization thereof may not be easily achieved. Therefore, a new-concept Si compound capable of solving the above-described problem, and a method of producing the same are required.

### PRIOR ART DOCUMENT

### Patent

(Patent 1) KR 1020050090218 (Publication Date: Sep. 13, 2005, Title of Invention: NEGATIVE ACTIVE MATERIAL FOR LITHIUM SECONDARY BATTERY, METHOD OF PREPARING SAME, AND LITHIUM SECONDARY BATTERY COMPRISING SAME)

### SUMMARY

The present invention provides an anode active material for a secondary battery, the material being capable of providing high-capacity and high-efficiency charge and discharge characteristics and of suppressing a reduction in cycle life due to excessive expansion of a silicon (Si) anode material, and a method of producing the same. The present invention also provides a technology of controlling porosity of a material coated on the surface of the anode active material. The present invention also provides an anode active material for a secondary battery, the material having carbon nanofibers (CNFs) grown on the surface thereof during the process of controlling the porosity, and a method of producing the same. The present invention also provides a secondary battery including the anode active material. However, the scope of the present invention is not limited thereto.

According to an aspect of the present invention, there is provided an anode active material for a lithium (Li) secondary battery, the material including silicon (Si)-based alloy powder, a carbonized layer at least partially surrounding the Si-based alloy powder serving as cores, and carbon nanofibers (CNFs) extending outward from a surface of the Si-based alloy powder through the carbonized layer.

In the anode active material, the CNFs may extend through micropores of the carbonized layer.

The anode active material may further include a deposited carbon layer at least partially surrounding the carbonized layer, and the deposited carbon layer may be generated to fill the micropores of the carbonized layer and suppress an increase in surface area of the carbonized layer due to the micropores.

In the anode active material, the carbonized layer may be generated by carbonizing a resin coat layer, and the deposited carbon layer may be generated by performing chemical vapor deposition (CVD).

In the anode active material, the Si-based alloy powder may contain a metal mixed with Si to form an alloy, and the metal may include at least one selected from among iron (Fe), nickel (Ni), cobalt (Co), manganese (Mn), copper (Cu), vanadium (V), chromium (Cr), molybdenum (Mo), palladium (Pd), magnesium (Mg), aluminum (Al), and titanium (Ti).

In the anode active material, the Si-based alloy powder may contain Si by 60 wt % to 80 wt % and contain the metal by 20 wt % to 40 wt %.

According to another aspect of the present invention, there is provided a method of producing an anode active material for a lithium (Li) secondary battery, the method including providing silicon (Si)-based alloy powder, generating a carbonized layer by carbonizing a resin coat layer at least partially surrounding the Si-based alloy powder serving as cores, and generating carbon nanofibers (CNFs) extending outward from a surface of the Si-based alloy powder through the carbonized layer, based on chemical vapor deposition (CVD).

In the method, the generating of the carbonized layer by carbonizing the resin coat layer may include generating a solution by dissolving at least one selected from among polyfurfuryl alcohol resin, sucrose, coal tar pitch, phenolic resin, and epoxy resin, in propylene glycol monomethyl ether (PGME), cyclohexane, hexane, N-methylpyrrolidone (NMP), toluene, xylene, or heptane, generating the resin coat layer at least partially surrounding the Si-based alloy powder serving as cores, by drying the solution at a temperature of 80° C. to 200° C., and generating the carbonized layer by carbonizing the resin coat layer in an inert gas atmosphere at a temperature of 600° C. to 1,000° C.

According to another aspect of the present invention, there is provided a method of producing an anode active material for a lithium (Li) secondary battery, the method including providing silicon (Si)-based alloy powder, and generating carbon nanofibers (CNFs) extending outward from a surface of the Si-based alloy powder, based on chemical vapor deposition (CVD).

In the methods, the generating of the CNFs may include generating the CNFs by supplying acetylene, ethylene, methane, benzene, or carbon monoxide into a CVD reaction chamber and then performing CVD.

According to another aspect of the present invention, there is provided a lithium (Li) secondary battery including the anode active material.

### BRIEF DESCRIPTION OF THE DRAWINGS

The above and other features and advantages of the present invention will become more apparent by describing in detail embodiments thereof with reference to the attached drawings in which:

FIG. 1 is a flowchart of a method of producing an anode active material for a lithium (Li) secondary battery, according to an embodiment of the present invention;

FIG. 2 is a schematic image of the anode active material for the Li secondary battery, according to an embodiment of the present invention;

FIG. 3 is a graph showing X-ray diffraction of iron silicide (FeSi) anode materials according to a comparative example and embodiments of the present invention;

FIG. 4 is a graph showing thermogravimetric analysis (TGA) results of the FeSi anode materials produced according to the comparative example and the embodiments of the present invention;

FIGS. 5A to 5F are scanning electron microscope (SEM) images of the FeSi anode materials produced according to the embodiments of the present invention;

FIGS. 6A to 6C are transmission electron microscope (TEM) images of the FeSi anode materials produced according to the embodiments of the present invention;

FIGS. 7A to 7E are SEM images of surfaces of electrode plates made of the

FeSi anode materials produced according to the comparative example and the embodiments of the present invention;

FIGS. 8A and 8B are graphs showing capacity per cycle (FIG. 8A) and rate performance (FIG. 8B) as battery test results of the electrode plates made of the FeSi anode materials produced according to the comparative example and the embodiments of the present invention; and

FIG. 9 is a graph showing Raman spectroscopy analysis results of beta-FeSi2 phases of the FeSi anode materials produced according to the embodiments of the present invention.

### DETAILED DESCRIPTION

Hereinafter, the present invention will be described in detail by explaining embodiments of the invention with reference to the attached drawings.

Throughout the specification, it will be understood that when an element, such as a layer, a region, or a substrate, is referred to as being “on” another element, it may be directly on the other element or intervening elements may be present. In contrast, when an element is referred to as being “directly on” another element, there are no intervening elements present.

In the drawings, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing. The thicknesses or sizes of layers may be exaggerated for clarity of explanation, and like reference numerals denote like elements.

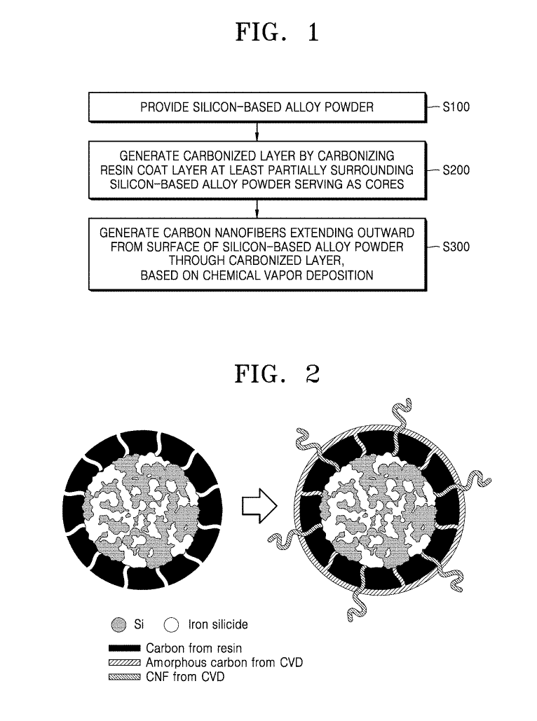

FIG. 1 is a flowchart of a method of producing an anode active material for a lithium (Li) secondary battery, according to an embodiment of the present invention, and FIG. 2 is a schematic image of the anode active material for the Li secondary battery, according to an embodiment of the present invention.

Referring to FIG. 1, the method of producing the anode active material for the Li secondary battery, according to an embodiment of the present invention, includes providing silicon (Si)-based alloy powder (S100), generating a carbonized layer by carbonizing a resin coat layer at least partially surrounding the Si-based alloy powder serving as cores (S200), and generating carbon nanofibers (CNFs) extending outward from the surface of the Si-based alloy powder through the carbonized layer, based on chemical vapor deposition (CVD) (S300).

The generating of the carbonized layer by carbonizing the resin coat layer (S200) may include generating a solution by dissolving at least one selected from among polyfurfuryl alcohol resin, sucrose, coal tar pitch, phenolic resin, and epoxy resin, in propylene glycol monomethyl ether (PGME), cyclohexane, hexane, N-methylpyrrolidone (NMP), toluene, xylene, or heptane, generating the resin coat layer at least partially surrounding the Si-based alloy powder serving as cores, by drying the solution at a temperature of 80° C. to 200° C., and generating the carbonized layer by carbonizing the resin coat layer in an inert gas atmosphere at a temperature of 600° C. to 1,000° C.

For instance, a resultant material of the generating of the carbonized layer by carbonizing the resin coat layer (S200) is shown at a left side of FIG. 2. Referring to FIG. 2, the Si-based alloy powder contains Si and iron silicide (FeSi). The carbonized layer generated by carbonizing the resin coat layer (i.e., “Carbon from resin”) at least partially surrounds the Si-based alloy powder serving as a core, and has a shell shape having micropores.

The generating of the CNFs extending outward from the surface of the Si-based alloy powder, based on CVD (S300) may include generating the CNFs by supplying acetylene, ethylene, methane, benzene, or carbon monoxide into a CVD reaction chamber and then performing CVD.

For instance, a resultant material of the generating of the CNFs extending outward from the surface of the Si-based alloy powder, based on CVD (S300) is shown at a right side of FIG. 2. Referring to FIG. 2, the CNFs generated based on CVD (i.e., “CNF from CVD”) extend outward from the surface of the Si-based alloy powder through the carbonized layer. For example, the CNFs may extend through the micropores of the carbonized layer. Due to CVD, a deposited carbon layer at least partially surrounding the carbonized layer (i.e., “Amorphous carbon from CVD”) may be further generated. The deposited carbon layer may be generated to fill the micropores of the carbonized layer and thus may suppress an increase in surface area of the carbonized layer due to the micropores.

The present invention relates to a Si-based-alloy anode material for a Li secondary battery and a method of producing the same, and more particularly, to an anode material for a Li secondary battery, the material capable of controlling porosity of a porous carbon layer generated by carbonizing alcohol resin, based on CVD, and the material having CNFs generated on the surface of particles during the process of controlling the porosity, and a method of producing the same.

The present invention provides a method of coating a carbon coating material on the surface of as-milled Si-based alloy, a method of controlling porosity of the carbon coating material and generating CNFs on the surface based on CVD, and Si-based alloy powder including CNFs generated on the surface thereof, and capable of controlling porosity thereof. As such, generation of a solid electrolyte interphase (SEI) layer due to direct contact with an electrolyte may be reduced by controlling porosity of the carbon coating material, and electrical conductivity of an anode layer may be increased by inducing generation of CNFs.

Specifically, for example, by coating polyfurfuryl alcohol resin on the surface of Si-based alloy powder and then performing CVD for thermal carbonization, an increase in surface area due to generation of small micropores may be suppressed and generation of carbon fibers may be promoted during carbonization of the resin coat layer. When the Si-based alloy powder is used as an anode active material for a Li ion secondary battery, generation of a SEI layer may be suppressed and electrical conductivity of an electrode plate may be increased during charge and discharge, and thus initial efficiency, cycle life, and rate performance of the Li secondary battery may be increased at the same time.

According to another aspect of the present invention, a Li secondary battery including the anode active material is provided. Elements of the Li secondary battery will now be described.

An anode includes an anode current collector and an anode active material layer located on the anode current collector. The anode active material layer includes an anode active material and an anode binder for binding the anode active material. The anode active material layer may optionally further include an anode conductive material. In addition, although not shown in the drawings, the anode active material layer may include an additive such as a filler or a dispersant. The anode may be generated by producing an anode active material composition by mixing the anode active material, the anode binder, and/or the anode conductive material in a solvent, and then coating the anode active material composition on the anode current collector.

The anode current collector may include a conductive material, and may be configured as thin conductive foil. For example, the anode current collector may include copper (Cu), gold (Au), nickel (Ni), stainless steel, titanium (Ti), or an alloy thereof. Alternatively, the anode current collector may include a conductive polymer, and may be generated by compressing the anode active material.

The anode active material may include a material capable of reversibly intercalating/deintercalating Li ions. According to example embodiments, the anode active material may include Si and a metal. For example, the anode active material may be configured as Si particles dispersed in a Si-metal matrix, and the metal may be a transition metal or include at least one of aluminum (Al), copper (Cu), zirconium (Zr), nickel (Ni), titanium (Ti), cobalt (Co), chromium (Cr), vanadium (V), manganese (Mn), and iron (Fe). The Si particles may have a nano size. Instead of Si, titanium (Ti), aluminum (Al), antimony (Sb), or the like may be used. The anode active material will be described in detail below.

The anode binder serves to bind particles of the anode active material together, and to bind the anode active material to the anode current collector. The anode binder may be, for example, a polymer, and may include, for example, polyimide, polyamideimide, polybenzimidazole, polyvinyl alcohol, carboxymethyl cellulose, hydroxypropyl cellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, or epoxy resin.

The anode conductive material may be a conductive material capable of providing more conductivity to the anode and of not causing a chemical change in a secondary battery, and may include a conductive material including, for example, graphite, carbon black, acetylene black, a carbon-based material such as carbon fibers, a metal-based material such as copper (Cu), nickel (Ni), aluminum (Al), or silver (Ag), a conductive polymer material such as a polyphenylene derivative, or a mixture thereof.

A cathode includes a cathode current collector and a cathode active material layer located on the cathode current collector. The cathode active material layer includes a cathode active material and a cathode binder for binding the cathode active material. The cathode active material layer may optionally further include a cathode conductive material. In addition, although not shown in the drawings, the cathode active material layer may include an additive such as a filler or a dispersant. The cathode may be generated by producing a cathode active material composition by mixing the cathode active material, the cathode binder, and/or the cathode conductive material in a solvent, and then coating the cathode active material composition on the cathode current collector.

The cathode current collector may be configured as thin conductive foil, and may include, for example, a conductive material. The cathode current collector may include, for example, Al, Ni, or an alloy thereof. Alternatively, the cathode current collector may include a polymer including a conductive metal. Alternatively, the cathode current collector may be generated by compressing the cathode active material.

The cathode active material may use, for example, a cathode active material for a Li secondary battery, and include a material capable of reversibly intercalating/deintercalating Li ions. The cathode active material may include Li-containing transition metal oxide, Li-containing transition metal sulfide, or the like, and include at least one of, for example, LiCoO₂, LiNiO₂, LiMnO₂, LiMn₂O₄, Li(NiₐCo_{b}Mn_{c})O₂ (where 0<a<1, 0<b<1, 0<c<1, and a+b+c=1), LiNi_{1-y}Co_{y}O₂, LiCo_{1-y}Mn_{y}O₂, LiNi_{1-y}Mn_{y}O₂ (where 0≤Y<1), Li(NiₐCo_{b}Mn_{c})O₄ (where 0<a<2, 0<b<2, 0<c<2, and a+b+c=2), LiMn_{2-z}Ni_{z}O₄, LiMn_{2-z}Co_{z}O₄ (where 0<Z<2), LiCoPO₄, and LiFePO₄.

The cathode binder serves to bind particles of the cathode active material together, and to bind the cathode active material to the cathode current collector. The cathode binder may be, for example, a polymer, and may include, for example, polyimide, polyamideimide, polybenzimidazole, polyvinyl alcohol, carboxymethyl cellulose, hydroxypropyl cellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, or epoxy resin.

The cathode conductive material may be a conductive material capable of providing more conductivity to the cathode and of not causing a chemical change in a secondary battery, and may include a conductive material including, for example, graphite, carbon black, acetylene black, a carbon-based material such as carbon fibers, a metal-based material such as Cu, Ni, Al, or Ag, a conductive polymer material such as a polyphenylene derivative, or a mixture thereof.

An isolation layer may have porosity, and may be configured as a monolayer or a multilayer. The isolation layer may include a polymer material, and may include at least one of, for example, a polyethylene-based polymer, a polypropylene-based polymer, a polyvinylidene fluoride-based polymer, and a polyolefin-based polymer.

An electrolyte (not shown) for dipping the anode, the cathode, and the isolation layer therein may include a non-aqueous solvent and electrolyte salt. The non-aqueous solvent is not limited to any particular type as long as a typical non-aqueous solvent for a non-aqueous electrolyte is used, and may include, for example, a carbonate-based solvent, an ester-based solvent, an ether-based solvent, a ketone-based solvent, an alcohol-based solvent, or an aprotic solvent. One of or a mixture of two or more of the non-aqueous solvents may be used. When a mixture of two or more non-aqueous solvents is used, a ratio therebetween may be appropriately adjusted depending on desired battery performance.

The electrolyte salt is not limited to any particular type as long as a typical electrolyte salt for a non-aqueous electrolyte is used, and may include, for example, a structural formula of A+B−. Herein, A+ may indicate alkali metal cations such as Li+, Na+, or K+, or a combination thereof. B− may indicate anions such as PF₆⁻, BF₄⁻, Cl⁻, Br⁻, I⁻, ClO₄⁻, ASF₆⁻, CH₃CO₂⁻, CF₃SO₃⁻, N(CF₃SO₂)₂⁻, or C(CF₂SO₂)₃⁻, or a combination thereof. For example, the electrolyte salt may be Li-based salt, and may include, for example, one or more selected from the group consisting of LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂. One of or a mixture of two or more of the electrolyte salts may be used.

### EXPERIMENTAL EXAMPLES

Experimental examples will now be described for better understanding of the present invention. However, the following experimental examples are provided only for better understanding of the present invention, and the present invention is not limited to the following experimental examples.

### COMPARATIVE EXAMPLE

### As-Milled FeSi

For comparison to embodiments, as-milled FeSi is produced using a ball mill. A composition thereof is as shown in Table 1.

TABLE 1

| | Si | Fe | Mn | Al | Cr |
|---|---|---|---|---|---|
| wt. % | 74.3 | 21.7 | 3.6 | 0.3 | 0.2 |

### Embodiment 1: Anode Material Produced by Carbon-Coating As-Milled FeSi by Using Polyfurfuryl Alcohol Resin (Resin@FeSi)

An anode material is produced by carbon-coating as-milled FeSi having the same composition as that of the comparative example, by using polyfurfuryl alcohol resin.

### Embodiment 2: Anode Material Produced by Double Carbon-Coating Anode Material Produced by Carbon-Coating As-Milled FeSi by Using Polyfurfuryl Alcohol Resin, Based on CVD (Resin+CVD@FeSi)

An anode material is produced by double carbon-coating the sample produced according to Embodiment 1, based on CVD.

### Embodiment 3: Anode Material Produced by Carbon-Coating As-Milled FeSi Based on CVD (CVD@FeSi)

An anode material is produced by carbon-coating as-milled FeSi having the same composition as that of the comparative example, by using the same CVD condition as that of Embodiment 2.

The FeSi anode materials carbon-coated based on CVD according to Embodiments 2 and 3 of the present invention include CNFs on the surfaces thereof.

In general, a Si-based anode material has a higher capacity than a carbon-based, and more particularly, graphite-based material, but volume expansion occurs up to 400% when Li is intercalated. On the contrary, volume contraction occurs when Li is deintercalated. As such, when charge and discharge are repeated, volume expansion and contraction are repeated and thus cracks occur. This leads to growth of a SEI layer due to an increase in contact area between an active material and an electrolyte, and thus an electrical short occurs in an anode and a battery life is seriously reduced.

The as-milled FeSi according to the comparative example of the present invention, which is produced using a ball mill and serves as a base material of the embodiments of the present invention, may contain Si by 50 wt % to 90 wt %, and more particularly, by 65 wt % to 75 wt %.

A Si compound containing a large amount of Fe and composed of Si and Fe compounds is called iron silicide (FeSi). According to the comparative example and the embodiments, a Si compound including at least one of nickel (Ni), cobalt (Co), manganese (Mn), copper (Cu), vanadium (V), chromium (Cr), molybdenum (Mo), palladium (Pd), MgO, Al₂O₃, etc. instead of Fe may be used.

According to the embodiments, for carbon coating, a solution may be generated by dissolving polyfurfuryl alcohol resin, sucrose, coal tar pitch, phenolic resin, epoxy resin, or a mixture of two or more of the afore-listed materials in PGME, cyclohexane, hexane, NMP, toluene, xylene, or heptane.

Alcohol resin may be coated on the as-milled FeSi by drying the solution in an oven at a temperature of 80° C. to 200° C. for 2 hours to 10 hours.

The alcohol resin may be carbonized by putting the dried sample in an alumina container, putting the container in a quartz tube furnace, purging the sample in a high-purity argon (99.9999%) atmosphere for 30 minutes to 1 hour, and then heat-treating the sample at 600° C. to 1000° C., and more particularly, at 750° C. to 800° C. for 30 minutes to 1 hour.

According to the embodiments, after the alcohol resin is carbonized, carbon-coated FeSi powder may be obtained in the form of lumps.

In the comparative example and Embodiment 1, carbon may be coated by performing CVD at a temperature between 600° C. and 1000° C., and more particularly, between 750° C. and 800° C.

When CVD is performed, acetylene, ethylene, methane, natural gas, benzene, (rarely) carbon monoxide, or the like may be used. However, considering toxicity, environments, etc., acetylene may be desirable. The powder coheres after CVD is performed by supplying a mixture gas of high-purity argon and another gas at a volume ratio of 8:2. The cohering particles are finely milled using a ball mill in a 30 Hz condition for 5 minutes.

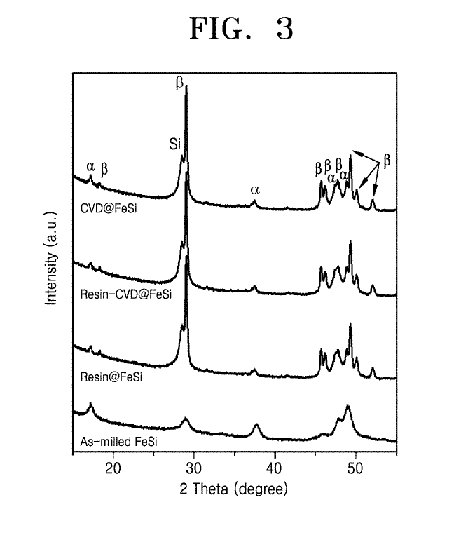

X-ray diffraction analysis results of the comparative example and the embodiments are shown in FIG. 3 and will now be described in detail.

In the as-milled FeSi according to the comparative example, peaks of Si (111) and beta-FeSi₂ at 28°/2theta and 30°/2theta are not easily distinguishable due to peak broadening. This means that Si and beta-FeSi₂ have become very finely crystalline or amorphous after being milled.

The X-ray diffraction analysis results of the embodiments do not show large differences. Compared to the comparative example, in the embodiments, peaks of Si (111) and beta-FeSi₂ at 28°/2theta and 30°/2theta are easily distinguishable. This may be because of heat treatment during carbon coating or CVD. A most part of alpha-FeSi₂ may be phase-changed into beta-FeSi₂ because the beta-FeSi₂ phase is thermodynamically stable at a high temperature (e.g., 937° C.) in a binary Fe-Si phase diagram.

A carbon content of the FeSi anode material carbon-coated based on CVD or based on a combination of carbonization of the polyfurfuryl alcohol resin and CVD according to the embodiment of the present invention may be 1 wt % to 20 wt %, and more particularly, about 10 wt % of the whole sample.

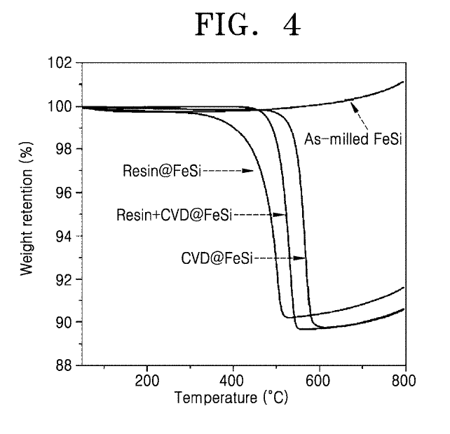

Carbon contents of the samples according to the comparative example and the embodiments may be measured based on thermogravimetric analysis (TGA) as shown in FIG. 4. The TGA results show that carbon burns at a temperature between 300° C. and 500° C. according to Embodiment 1 (Resin@FeSi), burns at a temperature between 450° C. and 550° C. according to Embodiment 2 (Resin+CVD@FeSi), and burns at a temperature between 500° C. and 600° C. according to Embodiment 3 (CVD@FeSi). The different temperature ranges, in which carbon burns, according to the embodiments are because of a difference in surface area due to porosity.

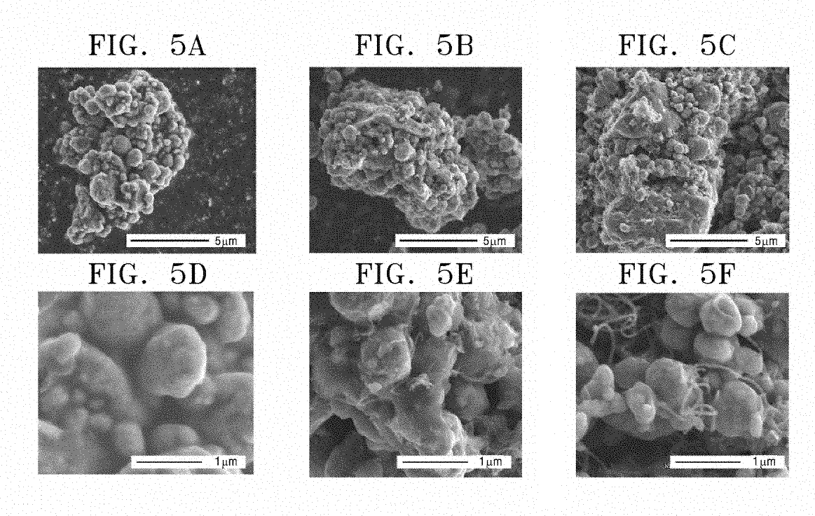

Referring to FIGS. 5A to 5F, it is shown that CNFs have grown on the surfaces of the FeSi anode materials carbon-coated based on CVD according to Embodiments 2 and 3 of the present invention. Scanning electron microscope (SEM) images of the surfaces according to the embodiments are illustrated in FIGS. 5A to 5F. Individual CNFs have a diameter of 1 nm to 100 nm and a length of 500 nm to 100 um, and preference for a certain size is not present. The CNFs grow only when CVD is used, and do not grow when only carbonization of the polyfurfuryl alcohol resin is used.

The CNFs may be generated due to catalytic reaction between an acetylene-based gas and Fe particles dispersed by the ball mill.

Specifically, for example, to grow the CNFs due to the catalytic reaction, usable as-milled particles may include FeSi described above or a Si compound including Ni, Co, Mn, Cu, V, Cr, Mo, Pd, MgO, Al₂O₃, or the like. A usable raw material of carbon for CVD may include acetylene described above, ethylene, methane, natural gas, benzene, (rarely) carbon monoxide, or the like. However, considering toxicity, environments, etc., acetylene may be desirable.

In the FeSi anode materials carbon-coated based on carbonization of the carbon resin and/or CVD according to the embodiments of the present invention, the coated carbon may serve to prevent release of the anode active material into the electrolyte through cracks occurring when a Li ion battery is charged and discharged.

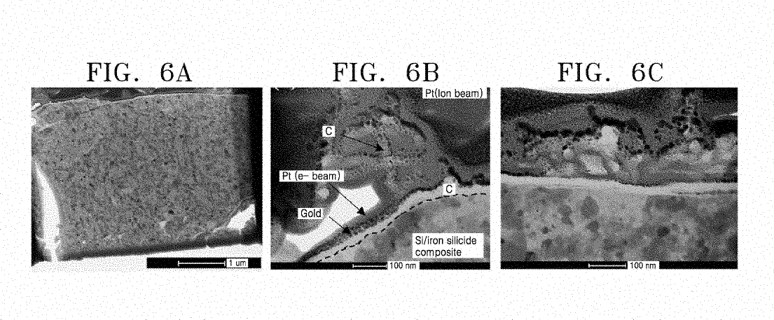

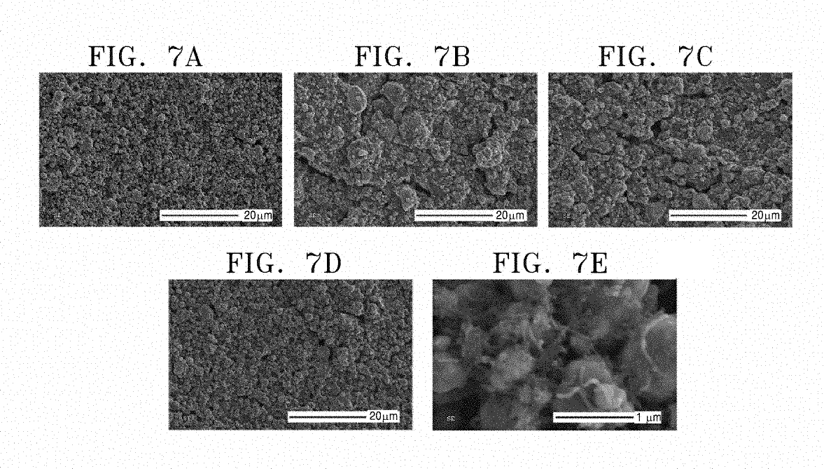

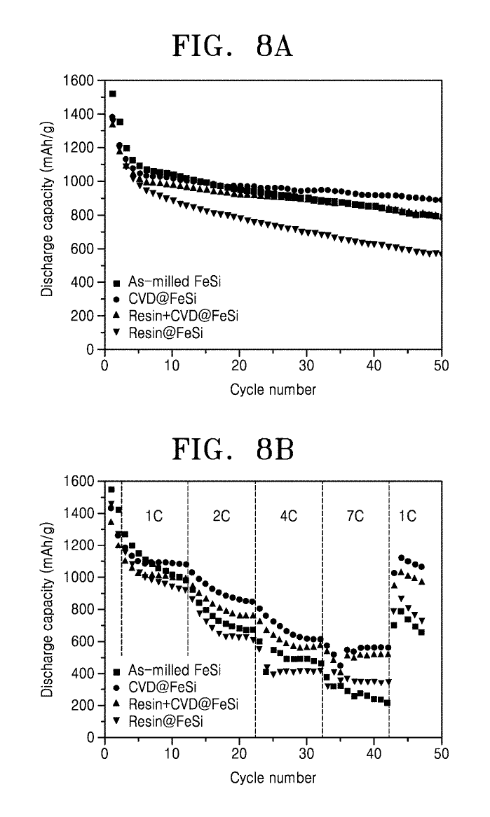

The thickness of the coated carbon is measured to be about 20 nm by using a transmission electron microscope (TEM) as shown in FIGS. 6A to 6C. However, the embodiments are not limited to the above-mentioned thickness of the coated carbon.

The CNFs grown on the surface according to the embodiments of the present invention may be retained in structure after a ball mill process performed as a post process for uniformly milling the condensing powder due to CVD. In addition, since the ball mill process may uniformly disperse the CNFs, electrical conductivity may be further increased.

According to Embodiments 1 and 2 of the present invention, a total surface area may be increased when the sample according to Embodiment 1 is produced. A large number of micropores may be generated when impurities in the polyfurfuryl alcohol resin are vaporized or gases are removed at a temperature between 700° C. and 800° C. According to the comparative example and Embodiment 1, a surface area of the as-milled FeSi may be 4.1 m²/g, and a surface area of the FeSi anode material carbon-coated by carbonizing the polyfurfuryl alcohol resin may be increased by more than 10 times, e.g., 51 m²/g. The increase in surface area due to the micropores generated as described above may activate generation of a SEI layer due to reaction with the electrolyte in a battery test. When generation of the SEI layer is activated, since the SEI layer is mostly configured as a non-conductor, problems such as a reduction in electrical conductivity and a hindrance to intercalation and dispersion of Li ions into the active material occur and thus a reduction in battery performance is caused.

The surface area may be reduced by depositing and filling carbon in the micropores based on CVD. A decrement of the micropores in volume may be equal to or higher than 90%, and a decrement of the surface area may be equal to or higher than 85%. Brunauer-Emmett-Teller (BET) surface areas and micropore volumes according to the comparative example and the embodiments are as shown in Table 2.

TABLE 2

| | BET | Micropore volume |
|---|---|---|
| | (m²/g) | (mm³/g) |
| As-milled FeSi | 4.1 | 0.0 |
| Resin@FeSi | 51 | 12 |
| Resin + CVD@FeSi | 7.2 | 0.7 |
| CVD@FeSi | 5.1 | 0.4 |

According to the embodiments of the present invention, the CNFs grown on the surface of the FeSi anode material carbon-coated based on carbonization of the alcohol resin or CVD may be amorphous or may be crystalline like graphite.

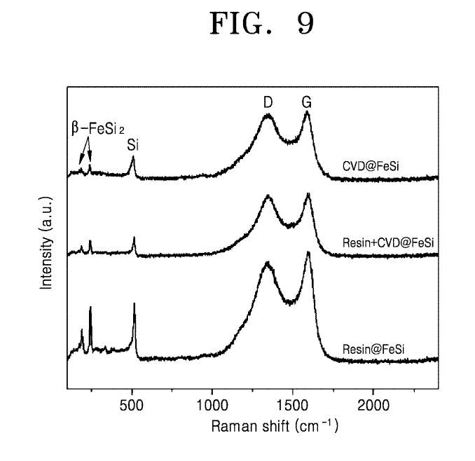

Referring to FIG. 9, based on Raman spectroscopy analysis results according to the embodiments, each of the materials according to the embodiments may include three periods, e.g., peak D (1360 cm⁻¹), peak G (1590 cm⁻¹), and band M (156 to 1320 cm⁻¹).

In the above-described anode active material for a Li secondary battery and the method of producing the same according to embodiments of the present invention, a Si-based-alloy anode material having grown CNFs on the surface thereof to achieve a small surface area and an increased electrical conductivity may be produced using a carbon coating material such as polyfurfuryl alcohol resin, and CVD. As such, a Li secondary battery capable of reducing irreversible capacity during charge and discharge of the battery, of increasing rate performance due to an increase in electrical conductivity, and of ensuring long life characteristics by reducing stress due to volume expansion may be produced.

As described above, according to embodiments of the present invention, an anode active material for a secondary battery, the material being capable of providing high-capacity and high-efficiency charge and discharge characteristics and of suppressing a reduction in cycle life due to excessive expansion of a Si anode material, and a method of producing the same may be implemented. However, the scope of the present invention is not limited to the above-described effect.

While the present invention has been particularly shown and described with reference to embodiments thereof, it will be understood by one of ordinary skill in the art that various changes in form and details may be made therein without departing from the spirit and scope of the present invention as defined by the following claims.

What is claimed is:

1. An anode active material for a lithium (Li) secondary battery, the anode active material comprising:
silicon (Si)-based alloy powder;
a carbonized layer at least partially surrounding the Si-based alloy powder serving as cores; and
carbon nanofibers (CNFs) extending outward from a surface of the Si-based alloy powder through the carbonized layer.

2. The anode active material of claim 1, wherein the CNFs extend through micropores of the carbonized layer.

3. The anode active material of claim 1, further comprising a deposited carbon layer at least partially surrounding the carbonized layer,
wherein the deposited carbon layer is generated to fill the micropores of the carbonized layer and suppresses an increase in surface area of the carbonized layer due to the micropores.

4. The anode active material of claim 3, wherein the carbonized layer is generated by carbonizing a resin coat layer, and
wherein the deposited carbon layer is generated by performing chemical vapor deposition (CVD).

5. The anode active material of claim 1, wherein the Si-based alloy powder contains a metal mixed with Si to form an alloy, and
wherein the metal comprises at least one selected from among iron (Fe), nickel (Ni), cobalt (Co), manganese (Mn), copper (Cu), vanadium (V), chromium (Cr), molybdenum (Mo), palladium (Pd), magnesium (Mg), aluminum (Al), and titanium (Ti).

6. The anode active material of claim 5, wherein the Si-based alloy powder contains about 60 wt % to about 80 wt % of Si and contains about 20 wt % to about 40 wt % of the metal.

7. A lithium (Li) secondary battery comprising the anode active material of claim 1.
